(19) United States
(12) Patent Application Publication
(10) Pub. No.: US 2005/0091272 A1
(43) Pub. Date: Apr. 28, 2005

(54) Contact management

(76) Inventors: Walter R. Smith, Seattle, WA (US); Amar Gandhi, Redmond, WA (US); Melissa W. Dunn, Woodinville, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 10/692,256

(22) Filed: Oct. 23, 2003

(51) Int. Cl. G06F 7/00

(52) U.S. Cl. 707/104.1

(57) ABSTRACT

Contacts are created and stored with corresponding contact information in such a way that they can be accessed and utilized by applications from a single contact store. The contact store contains a complete contact definition for each contact so that each of the applications can obtain the appropriate contact information and in the appropriate format from the contact store that is required by the applications. Centralizing the storage of the contact information allows the contact store to incorporate and propagate the changes that are made by the applications to the contact information. Interfaces can also be provided to initiate communications using the contact information and for controlling what contact information will be made accessible to the applications.

### BACKGROUND OF THE INVENTION

1. The Field of the Invention

The present invention relates to contact management systems for controlling how contact information is stored and made available to one or more applications.

2. Background and Relevant Art

A contact management system is generally referred to in this application as a system, directory or database that contains contact information about people, groups, organizations, businesses, households, or any other identifiable entity, each of which is referred to herein as a contact.

As the computer industry continues to develop new and efficient means for communicating with contacts are becoming a reality. It is now commonplace, for example, for people to use their personal computers to communicate via e-mail, facsimile, instant message (IM), telephony, video teleconference (VTC), and so forth. This development of enabled communication through computerized devices has greatly enhanced the need for applications to store the contact information that is required for enabling communication and corroboration between contacts.

Contact information is generally referred to herein as information that can be considered relevant for contacting, accessing, corresponding with or otherwise communicating with a contact. Contact information may include, for example, the names, aliases, telephone numbers, e-mail addresses, IM addresses, home addresses, and web addresses of a contact. Contact information can also refer to other types of information such as a real time status, location or disposition of a contact. For example, information indicating a contact is currently connected to a network or on a telephone line may also be broadly construed as contact information.

Because there are so many different types of contact information, it can be difficult for anyone to remember all of the contact information that is associated with the various contacts that they communicate with. The difficulty in remembering contact information is even further magnified by the fact that different applications require different types of contact information and sometimes different formats of contact information.

Accordingly, many applications are configured to store this information so that users do not have to commit it to memory. For example, e-mail applications typically utilize directories that are configured for storing the e-mail addresses of contacts that can be e-mailed. Likewise, telephony applications typically utilize directories for storing telephone numbers of contacts that can be called telephonically. Other non-limiting examples of applications that store contact information include time management applications, instant messaging applications, network gaming applications, business directory applications, VTC applications, and so forth.

In order for a user to obtain the contact information that will be used by a particular application, such as, for example, to initiate a communication or to fill out a form, a user can query the specialized contact information directory that is associated with the application. This step of accessing a directory associated with an application, however, is somewhat undesirable because it can increases the total amount of time that is required of the user. Even when the contact information is already known, the delay in time it takes to manually enter the known contact information can also be undesirable.

Yet another problem with specialized application directories is that they are typically designed to store only limited amounts of information. For example, some contact information directories are only configured to store the contact information that is specifically required by the associated applications (e.g., a directory associated with a telephony application may only be configured to store the telephone numbers and not e-mail addresses). Therefore, the amount of contact information that a user can obtain from any particular application can be somewhat limited.

The use of contact directories also extends to devices that are not considered traditional computers. For example, many telephones, facsimile devices, and photocopying devices also include contact directories for storing contact information that may be used to perform a desired function such as initiating a telephone call, a facsimile transmission, or a telecopy transmission.

Despite the benefits provided by existing contact management systems, the large variety of specialized and disparate contact management directories that are associated with the various applications and devices can make it difficult for users to quickly access all of the available contact information that corresponds to a particular contact. This is particularly true when considering that some of the disparate contact management directories contain different contact information.

One reason this can be problematic is that it can increase the difficulty for a user to identify all available means for communicating with a contact because it may require the user to separately access various directories from many different contact management systems in order to obtain the desired contact information. For example, it may be necessary to access a telephone directory to obtain the home or cell telephone number for the contact, an e-mail directory to obtain a primary e-mail address for the contact, a business directory to obtain the business telephone number, and business e-mail address of the entity, and so forth.

Having disparate contact directories can also be problematic for obtaining different types of contact information about different contacts. For example, it may be desirable to view the e-mail address of a first contact, the business telephone number of a second contact, and the cell telephone number of a third contact. If the desired contact data for each of the different entities is located in a different contact management system of different applications, then each application will have to be accessed to obtain the desired information, thereby requiring the undesirable expenditure of time and resources.

Searches and queries for specific contacts or contact information must also be performed separately on each of the various contact directories. It will be appreciated that this can be particularly problematic when a user has forgotten in which of the contact directories the contact information is stored.

To overcome some of these problems, some contact management systems are configured to redundantly store contact information that is not necessarily required for use by the corresponding application. For example, an e-mail directory may be configured to store the addresses, phone numbers and other information about the various contacts, even though this information is not required to enable e-mail communications.

The variety of directories and corresponding storage capabilities, however, can vary from one application to the next, thereby increasing the difficulty for users to know which of the contact information can be duplicated in each of the different directories. Furthermore, even when it is possible for portions of the contact information to be redundantly stored in each of the different contact directories, such redundant storage would represent undesirable and unnecessary expenditure of computing resources.

Yet another problem with redundantly storing contact information within existing contact directories is that it can be difficult to propagate changes to the contact information throughout all of the various contact directories that are storing the modified contact information. In particular, the separate storage of the contact information in each of the directories necessitates that the change to the contact information be entered into each of the directories. Otherwise, the contact information that is available will be inconsistent and possibly incorrect.

Another problem with existing contact management systems is that because they are so specialized, they fail to provide very extensive and rich search and view capabilities of the contact information. In particular, most contact management systems are relegated to providing only two-dimensional columns or lists of the stored data. Yet another problem with existing contact management systems is that they do not enable a user to view, create, and edit relationships between contacts. More particularly, existing systems do not enable a user to view the relationships existing between contacts or to create and edit these relationships.

Accordingly, there currently exists a need in the art for improved contact management systems and interfaces for accessing contact information.

### BRIEF SUMMARY OF THE INVENTION

The present invention is directed to improved methods, systems, and corresponding computer program products for managing contacts and corresponding contact information. More particularly, the invention is directed to improved contact management systems for controlling how contact information is stored and made available to one or more applications.

According to one aspect of the invention, a single concept of a contact is created for use by various applications. Corresponding contact objects and controls can be embedded in any application to represent the corresponding contacts much in the same way files can be referenced and represented.

The contacts are also created and stored with corresponding contact information in such a way that they can be accessed and utilized by applications from a single contact store. In one embodiment, the applications can be heterogeneous applications that utilize different portions of the contact information or utilize the same contact information in a different ways. In other embodiments, however, the applications can utilize the same contact information in the same way.

The contact store contains a complete contact definition for each contact so that each of the applications can obtain the appropriate contact information and in the appropriate format from the contact store as required by the applications.

Centralizing the storage of the contact information also allows the contact store to incorporate and propagate the changes that are made by the applications to other contact information directories. Accordingly, synchronizing the directories of the various applications can be performed efficiently from the centralized contact store, even though the contact information being synchronized may vary in format and content between the disparate application directories.

Security features can be provided through architectural structuring and corresponding interfaces to provide a desired level of security and protection to the contact store. For example, interfaces can interact with applications and users to restrict access to relevant and authorized contact information.

Various interfaces can be employed to provide the applications access to the stored contact information with dynamic filtering, querying, and auto-completing text capabilities. Interfaces can also be provided to initiate communications using the contact information and for controlling what contact information that will be made available to an application. Yet other interfaces can be used to display contact information in rich contexts.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of various applications and a data store.

FIG. 2 illustrates a relational diagram of a contact management system centralized around contacts.

FIG. 3 is an architectural diagram of one embodiment of a computing system in which methods of the invention can be practiced.

FIG. 4 illustrates a flowchart of various acts that can be performed for managing contacts and corresponding contact information according to certain methods of the invention.

FIG. 5 illustrates one embodiment of a user interface for displaying contact information.

FIG. 6 illustrates one embodiment of a user interface in which contact information is displayed with contact-centric tasks and links to a communication history and associated files of a contact.

FIG. 7 illustrates one embodiment of a user interface for displaying contact information and contact-centric objects.

FIG. 8 illustrates one embodiment of an interface list that can be used to identify contacts.

FIG. 9 illustrates one embodiment of a computer desktop interface that is displayed with contact controls and other icons.

FIG. 10 illustrates one embodiment of an e-mail application interface along with a persona selection interface and a corresponding information picker interface.

FIG. 11 illustrates one embodiment of an operating system that provides a suitable operating environment for the present invention.

### DETAILED DESCRIPTION OF THE PREFERRED EMBODIMENTS

The present invention is directed to methods, systems, and corresponding computer program products and interfaces for managing contacts and contact information that can be utilized by various applications.

As defined herein, the term “contact” generally refers to any person, group, organization, business, or other type of identifiable entity. The term contact can also include or imply an interaction, connection, relationship or association, between two or more entities. As stored in a centralized data store, the contact can include one or more data structures having fields that define or otherwise include the contact information corresponding to a particular contact.

The term “contact information,” as used herein, and which is defined above in more detail, generally includes information that corresponds to a contact and that may be considered relevant for identifying, contacting, accessing, corresponding or communicating with the contact. Contact information can also be defined as any information corresponding to a person. At certain times, herein, the term contact information and contact are used interchangeably, inasmuch as the term can be construed to broadly encompass the corresponding contact information.

The term “heterogeneous applications,” as used herein, refers to applications that utilize different portions of contact information corresponding to a similar contact and/or utilize the same portions of contact information, but in a different way. For example, different portions of contact information can include different data from different fields of a data structure defining a single contact. Likewise, by way of example and not limitation, heterogeneous applications can use similar portions of contact information in different ways when one application uses contact information to auto-complete a type-in line and another application uses the same contact information to initiate a communication, as described herein. It will be appreciated, however, that the invention is not limited in practice to providing contact information to heterogeneous applications. Instead, the scope of the invention also extends to embodiments in which similar applications utilize contact information in similar and identical ways.

In various embodiments described herein, interfaces are used to control association of and access to contacts and corresponding contact information. These interfaces can be created, modified and used through computer software components, which are sometimes referred to herein as computer-executable instructions or computing modules.

As described herein, a programming interface (or more simply, an interface) may be viewed as any mechanism, process, protocol for enabling one or more segment(s) of code to communicate with or access the functionality provided by one or more other segment(s) of code, such as, for example, to access contact information. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Accordingly, it will be appreciated that the embodiments of the invention can include special purpose and general-purpose computing devices including various computer software and hardware that can be used to enable the interfaces described herein. The embodiments within the scope of the present invention can also include computer-readable media for carrying or having the computer-executable instructions or data structures stored thereon that comprise the interfaces and the code for using and modifying them.

It will be appreciated that the computer-readable media can be any available media that can be accessed by a general purpose or special purpose computer, including, but not limited to mobile communications devices. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. The computer-executable instructions comprise, for example, instructions and data which cause a general purpose computer, special purpose computer, or special purpose processing device to perform a certain function or group of functions, such as the acts and steps described below.

When information is transferred or provided over a network or another communications connection (either hardwired, wireless, or a combination of hardwired or wireless) to a computer or mobile communications device, the computer/device properly views the connection as a computer-readable medium. Thus, any such connection is properly termed a computer-readable medium. Combinations of the above should also be included within the scope of computer-readable media.

Contact Management

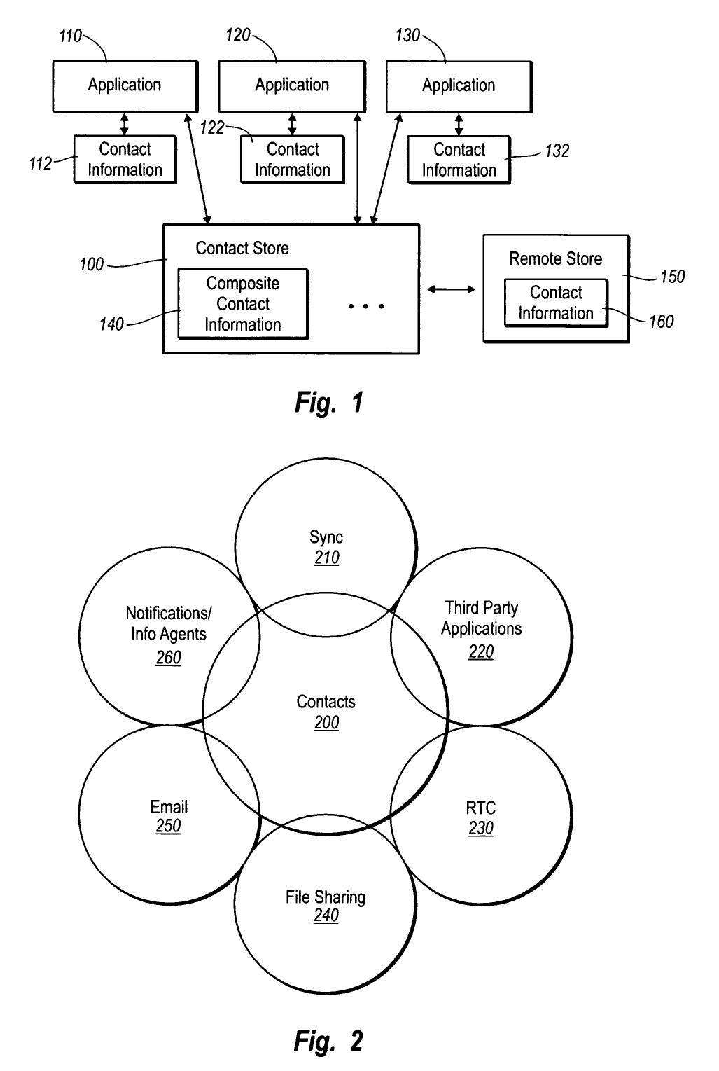

According to various methods and systems described herein, contacts and contact information are stored in a centralized contact store 100, as shown in FIG. 1. Although the centralized contact store 100 can comprise a single computer readable media, it will be appreciated that in some embodiments, the contact store 100 actually comprises a plurality of computer-readable media, such that the contact store 100 is centralized only in theory and by way of functionality.

The centralized contact store preferably includes a complete definition of a contact, including all of the corresponding contact information that is required by the various applications that access the contact. In some embodiments, however, the definition of the contact is only partially complete, but still able to satisfy the information requirements of the various heterogeneous applications that access the contact.

As shown in FIG. 1, various applications 110, 120, 130 are shown to be in communication with the contact store 100. Such communication or access can occur directly or indirectly. Where direct communication can provide quick and unfettered access to the entire contact store, indirect communication such as through interfaces can provide more control and security, as described herein. It will be appreciated that the illustrated applications 110, 120, 130 can be hosted by the same computing device that is hosting the contact store 100, or by one or more remote computing devices.

As described herein, the applications 110, 120, 130 may access the contact store 100 for various reasons, such as to provide, obtain, modify, or otherwise utilize contact information. The applications 110, 120, 130 can include any type of application, including, but not limited to e-mail applications, telephone and telephony applications, time management applications, instant messaging applications, gaming applications, business directory applications, VTC applications, RTC applications, instant messaging applications, facsimile applications, and so forth.

In some circumstances, as shown, each of the applications 110, 120, 130 can have access to corresponding directories 112, 122, 130 that store respective contact information. In other embodiments, as described below, the applications 110, 120, 130 can rely entirely on the contact information in the contact store at all times.

Inasmuch as each of the applications 110, 120, 130 can access separate contact directories 112, 122, 132, the contact store is configured to incorporate and merge the various contact information contained in the various contact directories 112, 122, 132 into composite contact information 140. For example, directory 112 could include telephone numbers of a contact, directory 122 could include e-mail addresses of the contact, and directory 132 could include some of the same telephone numbers of the contact as contained in directory 112, but in a different format (e.g., prefaced by an area code). In such an example, the composite contact information 140 corresponding to the contact, which is stored in the contact store 100, could include all of the contact information from the various directories 112, 122, 132.

In some embodiments, the information from various heterogeneous directories is inconsistent or conflicting. In such circumstances, the contact store can composite all of the information into a single record or, alternatively, interfaces can be present to the user, notifying them of conflicts, such that obsolete information is disregarded and not included in the composite contact information 140, as described below in more detail.

FIG. 1 also illustrates how the contact store 100 can be placed in communication with a remote store having a separate copy of contact information 160. As described below, this embodiment is useful for enabling syncing between different computing devices, such as for example, a PDA and a desktop, or a network node (e.g., personal computer) and a network hub (e.g., server).

The foregoing examples and description have been provided to illustrate certain configurations and embodiments in which a centralized contact store 100 can be accessed by local and remote applications and systems.

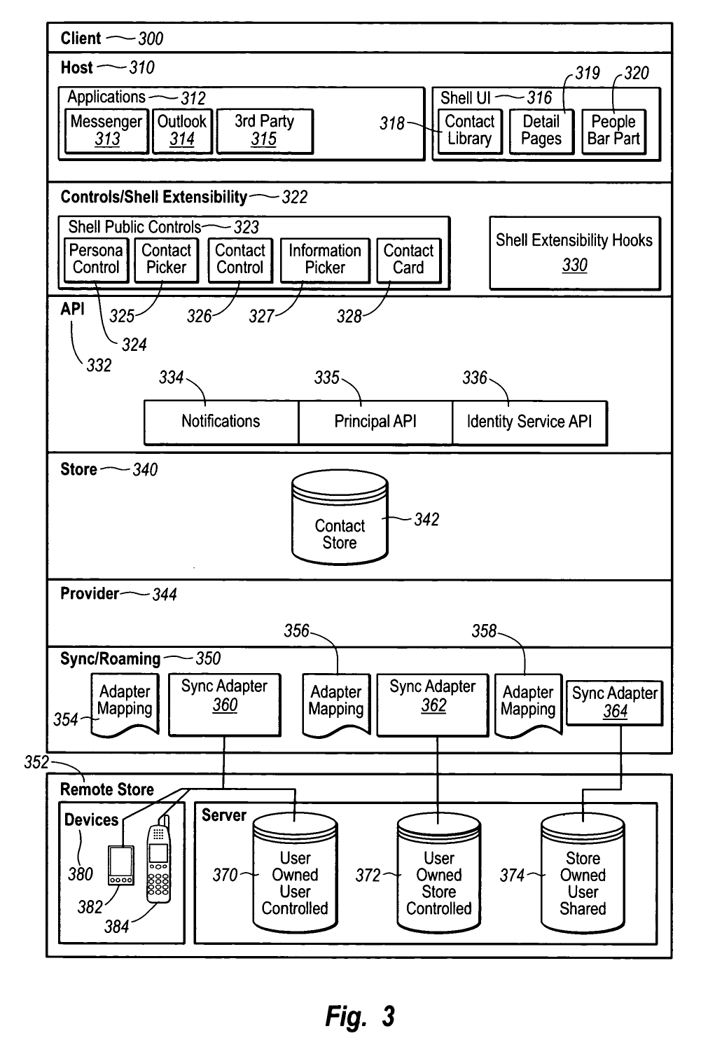

FIG. 2 further illustrates how the centralized concept of a contact can be utilized to enable functionality and utility for various contact management applications, including various shell and third party applications. For example, contacts 200 are made available, through appropriate interfaces and API layers, as described in FIG. 3, for syncing 210, remote third party applications 220 (e.g., Internet applications), RTC (Rich Text Communication) 230, file sharing 240 (e.g., photo's, documents, videos, etc.), e-mail 250, and notifications/information agents 260. The present illustration is not intended to limit the scope of applications that can utilize centralized contact information, as described herein, but rather is presented merely as an illustration to emphasize how the centralized theory of a contact can be used to interconnect various applications and system capabilities.

FIG. 3 is now presented to illustrate an architectural overview of a system in which contact information is accumulated and centralized in a contact store. As shown, a client system 300 includes various layers, each of which will now be described. The illustrated host layer can be thought of as an application layer that contains applications that are expected to host the contact controls described in the controls layer 322.

The applications 312 of the host layer 310 can include any applications that are server-based, such as Web site and services, client-based operating system applications, and third party applications. The present example illustrates only some of many potential applications, including Messenger 313 and Outlook 314 that are provided by Microsoft Corp., as well as a third party application 315.

The host layer is also shown to include certain user interfaces of the shell, at Shell UI 316, which are sometimes described herein as a means for controlling and enabling access to the contacts in the contact store. Some of the interfaces that are described below comprise shell user interfaces, such as the contact library interface 318, details page 319, and the people bar part 320.

Other interfaces described below are referred to in the present illustration as controls (324, 325, 326, 327, 328) that are disposed in the controls/shell extensibility layer 322. In particular, the shell public controls 323 include additional interfaces that can be classified broadly as either host-able or callable. Host-able controls can be integrated directly into an application by a developer. Some examples of host-able controls include the persona control 324, contact control 326 and contact card 328, each of which are described in more detail below.

Callable controls are controls that are self-sufficient user interfaces that can be called by an application, but are not hosted directly within the application's domain namespace. This separation of namespace allows the callable controls to directly access the contact store without enabling the application to manipulate the contact store without the user's knowledge and consent. Some examples of callable controls include the contact picker 325 and information picker 327, as described in more detail below.

Next, the API layer 332 includes application programming interfaces (API's) that are used to make and reply to calls for contact information to and from the various applications and interfaces. Examples of some API's include shell notifications API 334, a principal API 335, and an identity service API 336.

The shell notifications API 334 is used for monitoring and enforcing rules about when and how a user gets notified when actions such as contact information and associations are changed on a local or remote store, when a sync has completed/failed, etc.

The principal API 335 is used to provide contact schema behaviors and for associating identifiers (e.g., email addresses, passport identifiers, security identifiers, etc.) with contacts. The principal API 335 also allows contacts to be related, based on their identifiers.

The identity service API 336 supports the underlying structure for determining whether an incoming contact representation can map to a stored contact, as well as supporting the recognition of a contact.

The next illustrated layer is the store layer 340, which includes the contact store 342 having contact profiles, schema data, persona characterizations, contact definitions and other contact information as described throughout the application and related applications identified herein.

Next, the provider layer 344 can be configured to support remote store queries to the contact store 342 in a controlled and secure manner.

The sync/roaming layer 350 provides access to contacts on roaming stores, such as, for example, as maintained by a remote server 354 through various sync adapters 354, 356, 358 and mapping adapters 360, 362, 364 that enable syncing and mapping of contacts and corresponding contract information, as described herein.

The various sync and mapping adapters correspond with the various roaming stores 370, 372, 374. Access to the remote stores can be accomplished through a wired network connection or a wireless network connection, such as may occur when using portable devices 356 such as a PDA 358 or cell phone 360.

One benefit of the roaming stores 370, 372, 374 is that users can access the roaming stores even when they are away from their desktop computer (e.g., client 300). For example, a cell phone 384 or PDA 382 might contain only a restricted listing of contact information, such that when a user is on the go, access to a more complete listing of contacts and contact information is desirable. Through the use of the remote stores and the syncing capabilities described herein, it is possible for the user to then connect with the roaming servers, while on the go, such as, for example, through a wireless connection or a remote hub, to obtain desired and updated contact information that may not be available on the user's portable devices 380.

There are three basic types of roaming contact stores 352 that can be utilized during roaming, including stores solely owned and controlled by the user 362, those owned by the user but controlled by the store 364, and those owned by the store and shared by the user 366.

A user owned/user controlled store 370 is a remote store that a user can place as many contacts and contact information into that they desire, of any type, up to the storage capacity allotted by the store 370. Examples of a user owned and controlled store 370 includes an MSN Address Book or Exchange file.

A user owned/store controlled store 372 places restrictions on the types of contacts that can be stored. Examples of a user owned/store controlled store 372 includes Messenger Buddy Lists where the contact must have an IM address or an authentication certificate. Another example is a Share Point where a contact must be within the same network domain as the server.

Store owned/user shared stores 374 do not allow the user to modify any contact information stored therein, with the possible exception being the user's own information. In such a store 374, the user is given read access to the stored entries, but cannot add, delete or modify the entries. Examples of some store owned/user shared stores 374 include Internet Directories, such as MSN white pages or member directories and active directories within a corporation.

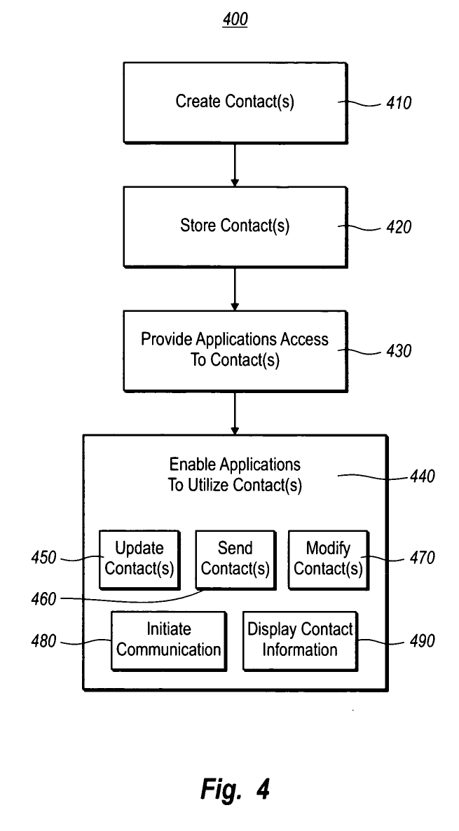

The foregoing description has been provided to illustrate one suitable environment in which the methods and systems of the invention can be practiced. Now attention will be directed to FIG. 4, to describe certain acts and methods for practicing embodiments of the invention.

FIG. 4 illustrates a flowchart 400 of one method for managing contacts and related contact information according to certain embodiments of the invention. As shown, the method includes various acts that will now be described.

The first illustrated act is to create one or more contacts (act 410). This can include various processes and other acts. The creation of a contact can be performed locally, the client system hosting the contact store or on a remote system. Likewise, local applications and remote applications can be used.

The creation of a contact can include compiling contact information that is related to the contact and organizing it into a data structure. Examples of contact information that can be compiled are described above, and can include such things as telephone numbers, names, aliases, addresses, titles, etc. Contact information can also include status and disposition information corresponding to the contact. It will be appreciated that a contact need not be a person. Rather, a contact can be any person, group, organization, business, or other type of identifiable entity.

The creation of a contact can also include compiling contact information that defines or implies interactions, connections, relationships or associations, between two or more contacts.

According to one embodiment of the invention, each contact that is created is created in such a way that it can be accessed and utilized by heterogeneous applications, or, in other words, so that the contact can be utilized differently by different applications or so that different portions of the corresponding contact information can be utilized by the applications.

According to one embodiment, creating a contact also includes allowing the user to selectably control what contact information will be published or otherwise made available to the applications, as described below in more detail with regard to the information picker interface.

The creation of a contact can also occur dynamically by merging or syncing the contact information from two or more disparate contact directories or locations, as suggested in reference to the descriptions of FIGS. 1-3.

Merging occurs when two or more definitions corresponding to a particular contact are combined into a composite definition of the contact. Syncing occurs when one definition of a contact is modified to correspond with another definition of a contact. Syncing will most likely, but not necessarily, occur between disparate storage media, such as, for example, between the contact store and a remote store or an application directory.

According to one embodiment of the invention, synchronizing is performed automatically upon detecting that contact information is inconsistent or out of date with the contact store. Such a determination can be made by actively in a push-type system by notifying applications and remote stores of updated information, or, alternatively, in a passive pull-type system in which the client system waits for an application or remote store to request updated information.

Other ways in which a contact can be created include downloading contact information from a remote store or application directory. Even though the contact information is pre-existing, it is new and hence created for the client system.

Once the contacts are created, they are stored (act 420) in an appropriate location, such as the contact store 342, shown in FIG. 3, and/or in a remote store 352 so that they can be accessed by one or more applications (act 430).

During storage of the contacts, their corresponding contact information can be indexed and mapped, including relationships and associations between the contacts. This can be useful for enabling enhanced filtering and querying of the contact store, as described in the embodiments provided below.

An application is provided access to the contacts and corresponding contact information (act 430), according to one embodiment, through appropriate interfaces and APIs so as to ensure a desired level of security and privacy of the contact information. For example, as described above, certain interfaces will run from their own namespace, such as the contact picker and information picker dialogs, to prevent silent keystrokes from being used to access contact information without the user's express consent.

The interfaces and controls can also be configured to conditionally provide applications access to contact information only upon satisfying certain requirements, such as having an appropriate ACL, originating from a trusted source, being explicitly or implicitly authorized, etc.

Because there are virtually infinite types of interfaces and contact information that can be accessed through the interfaces, this application will not attempt to enumerate them all. Instead, various non-limiting examples of interfaces are provided below, which illustrate only some of the ways in which access to contacts and corresponding contact information can be accessed. Accordingly, it will be appreciated, that the descriptions and examples that follow are merely illustrative and should not, therefore, be construed as limiting the scope of the invention.

Upon providing an application access to a contact, the methods of the invention further include enabling the applications to utilize the contacts and corresponding contact information (act 440). Enabling an application to utilize a contact and contact information can include any combination of other acts. For example, enabling an application to update (act 450) the contact or contact information with new contact information can be construed as utilization. Likewise, sending (act 460) or modifying (act 470) the contact and contact information is construed as utilizing the contact.

Utilizing the contact information can also include such things as initiating a communication (act 480), like an e-mail communication, telephony communication, RTC communication, or other communication. A communication can be initiated, for example, by allowing the application to identify and extract appropriate contact information from a contact and apply that information to executable code specifically configured to initiate the communication.

In yet other embodiments, an application can utilize contact information by displaying it. For example, in many of the following interface embodiments, contact information can be display in rich contexts and formats to provide an informative and favorable viewer experience. These embodiments include only some of the myriad of ways in which contact information can be displayed.

In other embodiments, applications display contact information after first identifying the appropriate contact information to display. For example, in some embodiments, applications can display contact information that is obtained from a query, pivot, or filter of the contact store in response to a user request. Contact information can also be displayed at times even before it is requested, in an anticipatory type of way, as described below.

It should be appreciated that there are numerous ways in which contact information can be utilized by authorized applications, including, but not limited to, the ways that are specifically described in the following examples. Accordingly, the scope of utilizing contact information should be broadly interpreted to encompass any task that can be performed by an application with the contact information, once it has been accessed.

Now, several specific interfaces and controls and corresponding methods of use will be provided to further clarify the scope of the claims and the recited method of FIG. 4.

Contact Library Interface

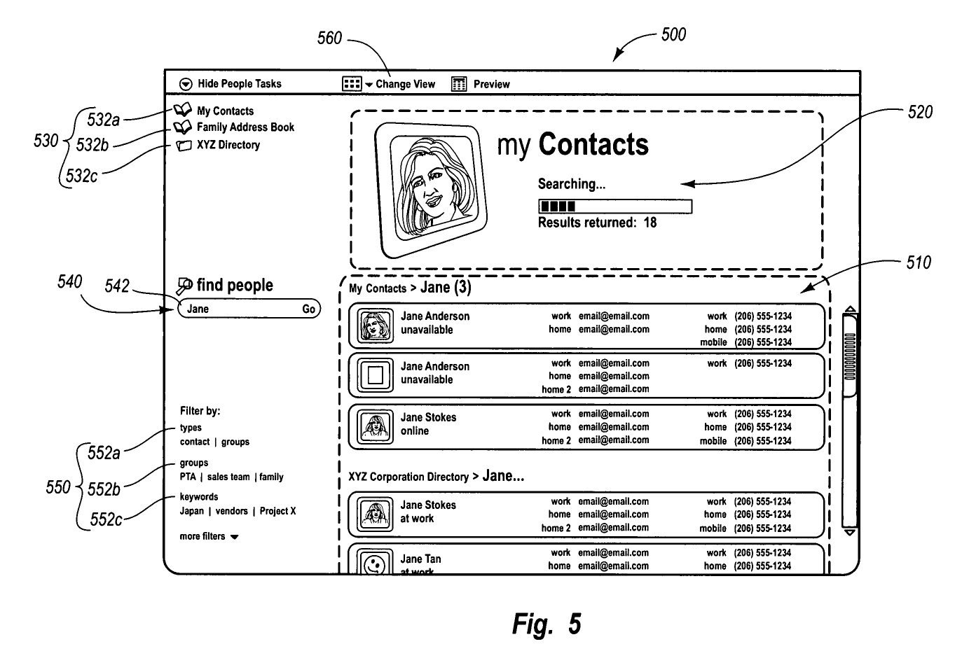

FIG. 5 illustrates one embodiment of a user interface 500 that may be utilized while performing certain acts of the invention. As shown, the interface 500 comprises a plurality of visual components including a primary display frame 510, a secondary display frame 520, a list 530 of directory links 532a, 532b, 532c, a search pane 540 with an input field 542, a list 550 of filters 552a, 552b, 552c and a pull down menu button 560 that can be selected to see a list of views that can be used to display contact information in the primary display frame 510.

The list 530 of directory links may identify any number of contact information directories from which contact information may be obtained. The contact information directories may be application specific directories, such as an e-mail application directory, or a network directory, such as a company information directory, or the that is preferably synchronized with the contact store 342. The directories may also comprise different physical partitions of the contact store. When one of the listed directories is selected, the interface 500 obtains and displays the contact information from the selected directory in the primary display frame 510.

In the present embodiment, the interface 500 displays contact information including the names, e-mail addresses, telephone numbers, and images associated with the contacts identified in the selected directory. It will be appreciated, however, that any amount of identifiable contact information can be displayed to accommodate different needs and preferences. Accordingly, the interface may include menus (not shown) for configuring the amount of contact information that will be provided. Likewise, even though a limited number of contacts is shown, it will be appreciated that the interface 500 may display any number of contacts as desired by sizing them appropriately. If the selected directory includes more contacts than displayed in the frame 510, then traditional tools for scrolling through or expanding the list of the additional contacts may be displayed and utilized by the interface 500.

When a contact is selected, such as with a mouse pointer or any other means, the contact information corresponding to the selected contact can be displayed in the secondary frame 520. In one embodiment, the contact information displayed in the secondary frame 520 consists of the same contact information displayed in the primary frame 510, only enlarged or rearranged. According to another embodiment, the contact information displayed in the secondary frame 520 includes additional information about the contact than is displayed in the primary frame 510. The secondary frame 520 may also display tasks that can be performed with that contact (e.g., send IM to the contact, send e-mail to the contact, and so forth).

The secondary frame 510 can also be used to provide contact information about the directory links listed in list 530. By way of example, the secondary frame 510 may display the contact information, such as a business card and image, for a business that corresponds with a business contact information directory, for example, and that is synchronized with the contact store.

As shown, the interface 500 also includes means for searching for key terms that may exist in the aggregate contact information of the plurality of disparate contact information directories. In particular, the search pane 540 may be used to enter a key term that may comprise part of a name, an address, or an attribute that can be used to search for desired contact information. For example, by typing the name “Jane,” one or more of the contact information directories is searched for contact information corresponding with the name “Jane.” As shown in the present embodiment, various Jane contacts from the My Contacts directory and the XYZ Corporation directory are displayed. It will be appreciated, however, that this example is merely illustrative and that a search can be performed by supplying other terms or symbols that are associated with a contact. For example, a search can be performed by supplying a telephone number and searching for one or more contacts associated with the telephone number.

It will also be appreciated that the invention extends to both embodiments in which a plurality of directories are searched, as shown, as well as embodiments in which only individually selected directories are searched. The key term that is entered may also comprise a filter term, such as an attribute characterizing a type of group or classification. For example, the key term “sales team A” may be used to identify all contacts belonging to sales team A. The types of classifications and groups that can be associated with the contacts is determined by the contact schema utilized by the client system.

Filtering can also be based on relationships between the contacts. For example, a filtered search can be performed for everyone in the same household as Contact A or who works for the same organization as Contact B, and so forth. The filters may be customizable and specifically tailored to search corresponding directories. For example, a job title filter may be provided when searching a corporate directory. Likewise, an online status filter may be provided when searching through the personal contacts directory, and so forth.

The interface 500 may also include a list 550 of filters that may be utilized with or without the search pane 550 for filtering the aggregate contact information by classification, as described above. Any number of filters may be used at the same time. The filters may be provided as links, as check box items, or as any other selectable object. The number and type of filters that may be included with the interface may be modified to accommodate any need and preference.

The interface 500 can also be configured to display contact in other views, such as an organizational view that reflects an organizational structure and placement of a contact within the organization. An event view can reflect an association between any number of contacts and a relevant date or event (e.g., a birth date, travel date, etc.). Views can also be selected to reflect a contact's location or proximity to other contacts. Yet other views can reflect the operability and capabilities of the contact's system with certain applications and other systems.

Contact Page Interface

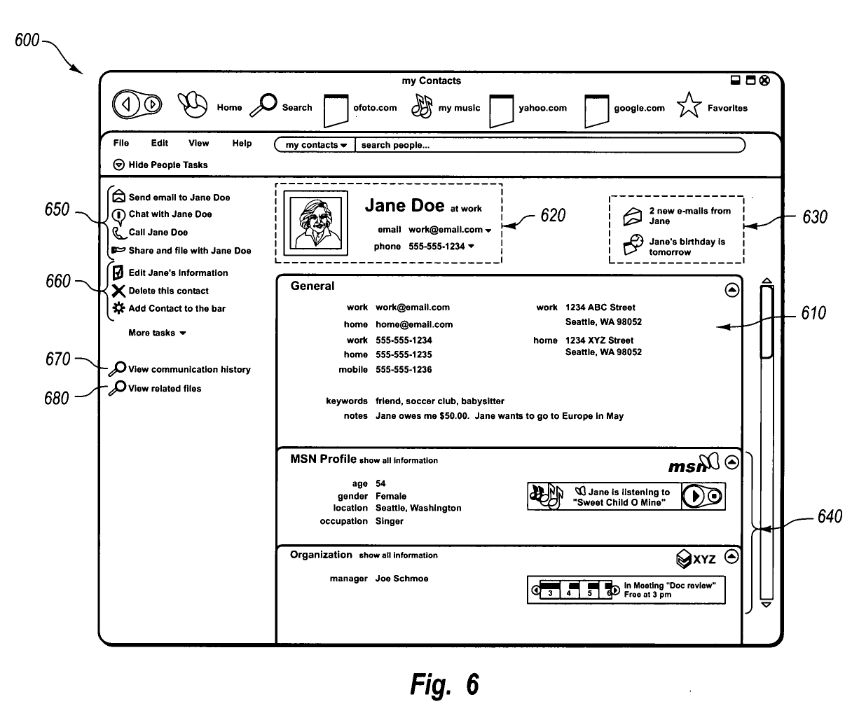

Turning now to FIG. 6, another embodiment of an interface is illustrated that can be used to display contact information corresponding to a contact. As shown at 510, some general contact information including e-mail addresses, phone numbers, and addresses associated with the contact (Jane Doe) are displayed by the contact page interface 500. The contact information also includes notes and keywords that have been associated with the contact by the user or another entity.

Some contact information is displayed in a condensed form that includes the contact's name, image, online status, and e-mail addresses and phone numbers, birth date, spouse, employment information (company, title, manager, direct reports, office #, etc), free/busy, children, etc., as shown at 620. The presence status of the contact (e.g., at work, online, at home, etc.) may be determined by the client computing system. The status may also be determined by any other suitable manner, including, but not limited to notifications that are sent by a server or other remote computer.

The preferred e-mail and phone number that are displayed with the condensed contact information at 620 can relate directly to the status of the contact. For example, if the contact is at work, the preferred e-mail and phone number may include the work e-mail and work phone number. Alternatively, the preferred e-mail and phone number may be predetermined and published by the contact. The preferred e-mail and phone number may also be designated by the user via the edit mode of the user interface.

According to one embodiment, the displayed contact information includes all e-mail addresses and phone numbers that are known to be associated with the contact (e.g., home, work, cell, fax, alternate, vacation home, additional lines, and so forth) with an indication as to which of the known e-mail addresses and phone numbers are preferred.

The image of the contact that is displayed with the contact information, at 620, can be provided by the user. The image may also be provided by any other entity.

As shown by FIG. 6 at 630, the contact information may also include the birthday of the contact, notifications of communications received by the contact, and any other desired contact information.

The contact information that is displayed by the user interface 600, may be obtained from one or more directories that are located in one or more local stores and/or in one or more remote data stores, as described above. The directories are, however, preferably synchronized, as described above, so as to avoid any inconsistencies.

According to one embodiment, the contact page interface is utilized in combination with one or more APIs through which third parties can add relevant information about the contact and that can be displayed on the contact page. Any contact information supplied by a third party through the one or more APIs may be displayed in frame 640 or another portion of the contact page. However, before such supplemental information is displayed, it is preferably synchronized with the contact information stored in the contact store.

FIG. 6 also illustrates how the user interface can be used to display other information, not considered traditional contact information. For example, the user interface 600 can display contact-centric tasks 650 that can be used to initiate an activity or communication with the contact. These contact-centric tasks 650 are preferably, but not necessarily, limited to the tasks that can be performed between the client system and a remote computing system.

It will be appreciated that the scope of the invention is not limited to any number or type of contact-centric task that may be displayed. For example, contact-centric tasks can also include actions or tasks that can be performed on a contact (e.g., add a contact to a group, edit contact information associated with the contact, and so forth). According to one embodiment, a third party can include tasks at any time that can be displayed at the contact page through the use of one or more APIs. These APIs may comprise part of the computer-executable instruction of the modules described above, or comprise discrete APIs that are separate from the modules described above.

The user interface 600 may also display links 660 for editing, deleting or adding new contacts, links 670 to contact communication histories, as well as links 680 to files that are associated with the contact. These links 670, 680 may include hypertext links, buttons, menu options, or any other suitable objects that are displayed by the user interface 600.

When the communication history link 670 is selected or another request to view a desired communication history is received, the user interface displays the desired communication history, which includes a record of communications sent by the contact and a record of communications sent to the contact. The types of communications that are displayed may include e-mail messages, instant messaging messages, telephony communications, presentations, and any other types of communications. The displayed history of communications can be obtained from one or more data stores corresponding with one or more communication applications (e.g., e-mail, instant messaging, etc.) or, alternatively, from the contact store.

Contact Card Interface

According to one embodiment, a lightweight contact card interface can appear as a fly out or balloon from a contact control (e.g., menu selection, icon, etc.), wherever it is embedded. In particular, the contact card interface can fly or balloon out of the contact control for enabling interaction by a user and then fly back when the interaction is complete. This example is provided to illustrate how the contact card interface can be utilized with third-party applications or other hosting applications without undesirably disrupting the functionality and utility of the hosting applications.

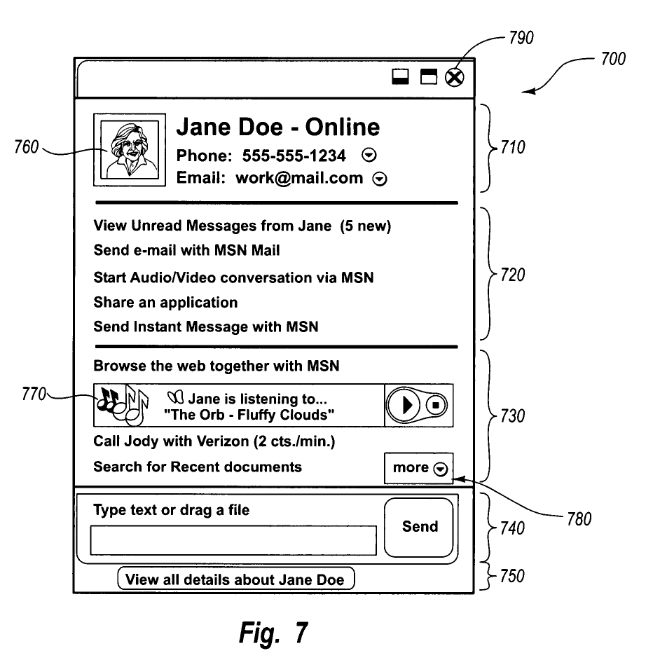

FIG. 7 illustrates one embodiment of a contact card user interface 700 that is displaying contact information 710 according to the invention. In this embodiment, the contact information includes, a name (Jane Doe), a telephone number, an e-mail address, an online presence status (Online/Offline), and an image that is associated with the contact (Jane Doe). This contact card 700 may be displayed, for example, when the name, image, or object associated with Jane Doe is selected from a menu, from a desktop interface, or from any other interface. Jane Doe's contact card 700 can also be displayed when a telephone call, an e-mail, a fax, an instant message, or any other communication is received from Jane Doe.

It will be appreciated that the contact store may store numerous contact cards for various contacts, each contact card having unique contact information corresponding with the contacts.

The present example shows that the contact card interface 700 may display the name, telephone number, network status, and e-mail address of a contact. It will be appreciated, however, that this example does not limit the scope of the invention. Rather, the contact card interface does not necessarily have to display each of the illustrated elements of contact information 710, nor is the contact card interface limited to displaying only the illustrated elements of contact information 710.

According to one embodiment, the contact information 710 that is displayed is at least in part based on the schema that is used to classify and categorize the contact information. In particular, the aforementioned contact schema enables the contact information to be prioritized so that certain primary contact information can be displayed while other contact information is hidden. This may be desirable, for example, when a large quantity of contact information is available, so as to avoid cluttering the user interface 700 with contact information that may not be needed every time the contact card is accessed. For example, when a large number of telephone numbers are associated with a contact, it may be desirable to prioritize the telephone numbers so that only the one or more frequently used telephone numbers are displayed.

If the contact card interface is configured to display contact information that is not currently available, then the contact card interface may display either blank fields or text where the contact information would otherwise be displayed, thereby indicating that the corresponding contact information is currently unavailable. For example, if a telephone number is presently unavailable, the term “Phone” may be followed by a blank or the text “unavailable.” Likewise, if an image associated with the contact, such as a picture, is unavailable, then the image display portion 760 may be blank or display a generic image, indicating no image is currently available or associated with the contact.

The contact card interface may also display controls, objects, or menus for editing the contact information in-line. For example, if no phone number is available, the user may input the telephone number directly into the contact card by typing the telephone number into the field next to the text “Phone,” which may be blank or filled with the text “unavailable” or other similar text. When contact information is edited, the edits to the contact information can be stored locally within the contact store and propagated to other remote stores, so that the edits can be reflected in the contact card the next time the contact card is accessed by the user from the client system or a remote system.

According to another embodiment, the contact information can be automatically edited. For example, if certain contact information is unavailable in local storage, prompting the text “unavailable” to be displayed, the contact card interface can then query remote directories in remote storage media, such as through the Internet or other network connection, for the contact information. Once the contact information is found, the contact information can be retrieved and automatically updated in the contact card and contact store. Based upon the foregoing examples, it will be appreciated that the display of contact information by the contact card interface is dynamic and can be dynamically edited through manual in-line editing and automatically, as described above.

As shown, the contact card can also include contact-centric tasks that represent the activities that can be performed by applications with contact information, such as, but not limited to such things as e-mail activities, instant messaging activities, time scheduling activities, file transfer activities, telephony activities, audio/visual activities, facsimile activities, and so forth.

Because the total number of available contact-centric tasks that are enabled may be more numerous than the contact card is configured to display, the contact card interface may filter the contact-centric tasks based on predetermined criteria. The contact-centric tasks may be filtered, for example, to display only the tasks that have been enabled by applications that have provided contact information to the computing system about the contact. This helps to prevent applications that are installed on the computing system from automatically populating the contact card interface with potentially undesirable listings of contact-centric tasks.

The contact-centric tasks may also be filtered by a contacts based on involvement or association with a group. For example, if a group has an instant messaging network established over the Internet, the contact card may filter the list of contact-centric tasks to omit the instant messaging capabilities of the group unless the contact is a member of the group.

The contact-centric tasks may also be filtered according to most frequent use or use within a predetermined period of time. For example, if a particular contact-centric task, such as sending facsimile, has not been utilized by the user of the computing system to engage or interact with the contact for a certain period of time, that contact-centric task may be omitted from the displayed list of contact-centric tasks.

As shown in FIG. 7, contact-centric tasks are displayed in two sections, a pinned section 720, and a most frequently used section 730.

In one embodiment, the pinned task section 720 has been separated from the most frequently used task section 730 to enable a user to separate contact-centric tasks that are preferred from all other contact-centric tasks. According to this embodiment, the pinned task section 720 only includes tasks placed in the pinned task section 720 by the user, or as assigned by the system designer. Any contact-centric tasks that are identified and enabled by subsequent software or hardware upgrades to the user's computing-system are thereafter listed in the most frequently used task section 730, assuming they satisfy any predetermined criteria, as described above. Any newly available contact-centric tasks may be placed at the top of the most frequently used task section 730 or any other portion of the contact card interface 700.

According to one embodiment, the contact-centric tasks displayed in the most-frequently used section 730 are arranged in descending order of most frequent use. It will be appreciated, however, that the contact-centric tasks may be displayed in any desired arrangement and according to any desired predefined criteria, other than according to a most-frequent use.

The tasks that are displayed may be displayed as text links and/or as rich image links. One benefit of providing rich image links is to provide a quick visual association with a task that can be recognized by the user. Rich image links can also be useful, from one aspect, for enticing a user to select the link. When a user selects the displayed task, the task is launched. The tasks may be added to the list by the user, by applications installed by the user, or by a third party. It will be appreciated that any number of modules and APIs may be used to facilitate the addition of tasks to the contact card.

In certain embodiments, the displayed contact-centric tasks are owned by the application hosting the contact card. For example, if the contact card is opened from a Microsoft Word document, the Word document can control what tasks are displayed and can therefore display appropriate contact-centric tasks that correspond with the application (e.g., edit this document with this contact, schedule a meeting with this contact, and so forth).

As further shown in FIG. 7, the contact card interface 700 supports rich mark-up formats for displaying the contact-centric tasks. In particular, the listen to music contact-centric task 770 is displayed in a rich mark-up format. The size and display constraints of the contact-centric tasks can be modified to accommodate various needs and preferences.

When a contact-centric task that is listed by the contact card is selected by a user, such as with a mouse prompt selection, then the application associated with the contact-centric task is launched. For example, the send e-mail with MSN Mail task, when selected, will launch the MSN mail application. The MSN mail application and other applications are launched by the contact card initiating a function call through the modules, API's and computing structure described in FIG. 3.

Contact Picker Interfaces

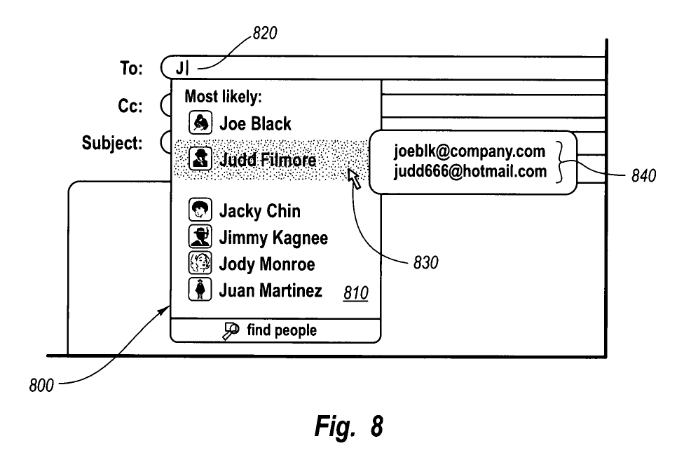

FIG. 8 illustrates an interface for intuitively displaying contact information. According to the present embodiment, the interface 800 intuitively displays a filtered list 810 of expected contacts that are determined to be most likely selected by the user. The determination as to what contacts are most likely to be selected by the user can be based on various criteria, including, but not limited to the frequency of selecting particular contacts, the last selected contacts, network or geographic proximity of the contact, compatibility of the contact's communication devices, the contact schema relationships, and so forth.

It will be appreciated that the displayed list of contacts, as described herein, can also be controlled by the application hosting the contact picker interface. In particular, the applications hosting the interface can specify any number or combination of required characteristics a contact must possess in order to be listed by the contact picker. For example, the hosting application can specify via an API to only show contacts who are online, to only show contacts with phone numbers, to only show contacts who reside in a particular region, to only show contacts having particular software installed on their computing systems, or to only show contacts having a predetermined combination of required characteristics, including, but not limited to those listed above. In this manner, the contact picker can effectively filter the list of the displayed contacts.

When one of the listed contacts is selected, such as with the click of a mouse pointer or with other selection input, the contact information corresponding to the selected contact, which is appropriate for the particular application, is inserted into the type-in line. What is considered “appropriate contact information” is generally application specific and corresponds to information that is required to perform a desired function with the application. For example, the appropriate contact information for an e-mail application may include the e-mail address of a contact that is necessary for sending an e-mail message. The appropriate contact information may also be specified according to other criteria, such as by the directory from which the contact information is obtained, and so forth.

According to one embodiment, the applications specify what contact information is required by the applications. For example, if an application requires an e-mail address then the application will specify to the user interface that the appropriate contact information comprises e-mail addresses so that they can be obtained and displayed by the user interface accordingly. It will be appreciated, however, that the user interface can also be configured with security mechanisms to prevent the application from obtaining contact information that is not required by the application.

It will also be appreciated that it is not necessary for the actual contact information utilized by the application to populate the type-in line. In particular, the type-in line may be populated with friendly names or other characters and objects that that link or point to the actual contact information utilized by the application. For example, in the e-mail context, the type-in line may be filled with the contact's ‘friendly name’ linking to an e-mail address, rather than the contact's actual e-mail address.

With specific reference to FIG. 8, the type-in line 820 has received input comprising the letter J. Having received this input, the interface 800 displays a list 810 of most likely contacts. This list 810 is generated from a search of the contact store or other directories that are synchronized with the contact store, as described above.

In this present embodiment, each of the listed contacts has a name beginning with the letter J, matching the input entered by the user. It will be appreciated, however, that the matching contact information does not need to include the characters of a name. For example, the matching contact information may comprise the characters or numbers of an address, a telephone number, or any other contact information. Contact information can also be matched based on user-added keywords (e.g., “college buddy”), that have been added by the user with another interface.

If one of the contacts is selected by the user, then the type-in line 820 is automatically populated with the appropriate and corresponding contact information of the selected contact. Alternatively, if the contact corresponds with more than one appropriate contact information option, then the plurality of contact information options can be displayed prior to populating the type-in line 820. For example, in the present embodiment, the contact Judd Filmore 830 has two e-mail addresses 840 that were discovered during the search. Therefore, both of the e-mail addresses 840 are displayed for selection. Once an e-mail address is selected, it populates the type-in line 820 with the appropriate contact information.

Although the previous example is provided with respect to e-mail functionality, it will be appreciated that the scope of the invention extends to other embodiments in which the contact information is utilized by other application to enable different functionality. For example, other applications may utilize the contact information to initiate a telephony session, initiate a telephone call, initiate a network connection, initiate a gaming session, access a website, perform a financial transaction, send material goods via postal mail, and so forth.

Likewise, it will be appreciated that the foregoing interface for selecting contacts can also be modified to include additional contact information about various contacts and can also provide other means for filtering through the contacts and contact information.

Contact Controls

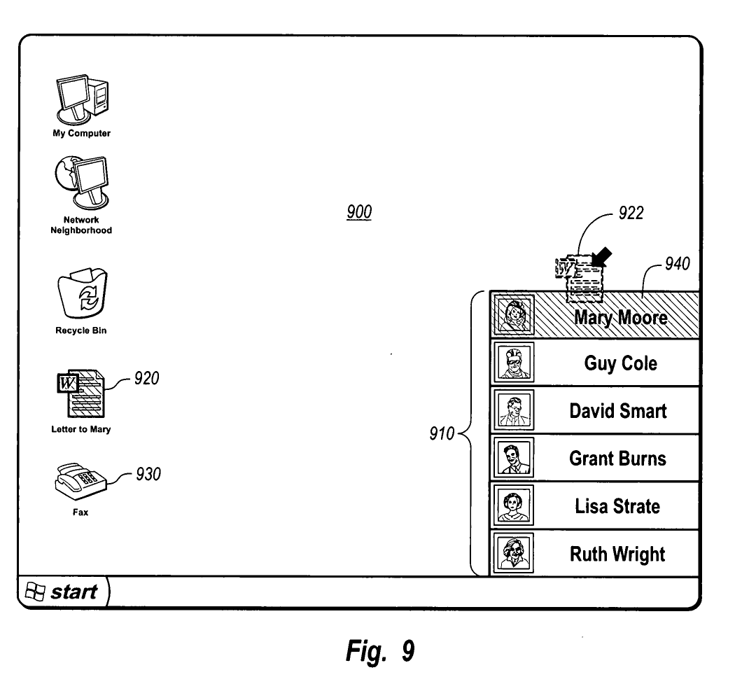

FIG. 9 illustrates a desktop interface 900 having various contact controls 910 being displayed that are associated with different contacts. The contact controls can be associated with people, groups, organizations, households, and other such contacts. The contact controls can display images that are associated with the contacts to provide a virtual presence and personality of the contact at the user's computer. The contact controls are linked to data sources that are associated with the contacts so that the associated data sources can be accessed when the contact controls are selected. The contact controls can also be used to initiate a communicative action with the contacts, as described below.

According to one embodiment, images/actions can be displayed as part of the contact control to convey a variety of information about the corresponding contact. Examples of images that can be displayed include, but are not limited to a clock image to indicate that the contact is either busy or available at the current time, a telephone image to indicate the contact is currently utilizing or connected with a telephone or telephony network, a flag to indicate that the contact has recently sent a communication to the user, a food image to convey the idea that the contact is currently on a break or out to eat, etc.

According to another embodiment, the contact controls can also be displayed with non-verbal images that convey emotional information about a contact. Emotional information may include the emotions being felt by the contact or emotions a user feels about the contact. This emotional information may be published by a contact or determined by a user viewing the contact control. For example, an animated face can be used to convey the contact is in a good mood, a heart image can be used to convey the contact is in a loving mood, that the contact loves the user, or that the contact is loved by the user, a frowny face can indicate the contact is in a bad mood.

The information that is used to make a determination as to what the status or emotional state of a contact is can be published by the contact and stored in the contact store.

According to another embodiment, the contact controls include friendly names or other contact information specified by a hosting application. This contact information may be displayed alone or with an image, such as with one of the images described above.

In one embodiment, for example, a user can access a more detailed user interface containing contact information about a particular contact by selecting the contact control. The contact information that can be obtained from selecting the contact control may include any contact information that is deemed relevant, including, but not limited to, the contact's name, e-mail address, a telephone number, a postal address, and an instant messaging address. This contact information can then be displayed in a card format or any other desired format.

The selection of a contact control can include any suitable means for selecting an object that is displayed by a computing system. In one embodiment, the contact control is selected by double clicking on the contact control with a mouse prompt. Selecting the contact control may also provide access to other information associated with a contact. For example, selecting a contact control may launch an application, like an e-mail application, to view any unread messages from the contact. Launching an application, such as an e-mail application by selecting the contact can also provide a means for sending a communication to the contact.

With specific reference to FIG. 9, a plurality of contact controls 910 are illustrated along with various application icons, including a Word document icon 920 and a facsimile device icon 930. In this embodiment, the contact controls 910 are displayed with names and images associated with particular contacts. The names and images can be real or fake.

FIG. 9 also illustrates how the contact controls can be used to initiate a communicative action with a contact. The term communicative action refers to any action involving communication including, but not limited to, initiating an instant message, an e-mail, an electronic file transmission, a facsimile, a video feed, a video teleconference, a telephony call, and a telephone call.

In one embodiment, for example, a file can be sent to a contact by dragging and dropping the file onto a contact control. In particular, a user can drag a phantom image 922 of the Word document file 920 onto contact control 940 to send a copy of the corresponding Word document to the contact that is associated with the contact control 940. Dropping the phantom image 922 of the Word document onto the contact control 940 initiates an instant message application, e-mail application, FTP application, or another application that is set as a default in the user's computer settings for sending Word documents.

It will be appreciated that the foregoing example is merely illustrative of one embodiment for initiating a communicative action using the contact controls of the invention. Accordingly, contact controls can also be used to initiate communicative actions in other ways. In another embodiment, an application can be initiated or sent to a contact when the contact control associated with the contact is dragged and dropped onto the icon or another launch object that is associated with the file or a host application. For example, if the contact control 940 were to be dragged and dropped onto the fax icon 930 then the fax application associated with the fax icon 930 would be launched. In another embodiment, dragging and dropping the contact control onto an application interface causes the application to add the contact and contact information associated with the contact control to the application's custom directory.

In one embodiment, whenever a communication application is launched in response to user input that involves a contact control, the communication application is automatically provided with the contact information that is necessary to initiate a communication with the contact. For example, if an e-mail application is launched in direct response to a user selecting a contact control or dragging and dropping the contact control on the e-mail's application icon, then the e-mail application will automatically be supplied with the contact's e-mail address so that the user doesn't have to enter it. The contact information can be accessed and provided through the modules, API's and computing architecture described in FIG. 3.

Similarly, if the e-mail application is already open, dragging the contact control into the “To:” line automatically populates the “To:” line with the e-mail address or other contact information that is necessary to complete the communication. Dragging and dropping the contact control directly into the body of the e-mail message can also attach the contact control to the e-mail message so that it can be sent to the intended recipient.

According to one embodiment, as mentioned above, the contact control can be hosted by third party applications without creating a burden on the third party applications. This does not, however, mean that the third party applications cannot exercise control over the contact control. For example, the third party applications may be configured to edit or otherwise control the display of the contact control image, such as by controlling when and where the contact control is displayed.

In some embodiments, the third party application can also control the interactive functionality of the contact control, such as, for example, by defining what occurs when the contact control is clicked on, dragged and dropped, etc. For example, an application may accept default settings that cause a single click on the contact object to launch a concise contact card containing limited amounts of contact information (e.g., name, address, e-mail address, telephone number, and so forth) and that causes a double click on the contact object to launch a detailed contact page including additional information and links associated with the contact. The hosting application may, however, override and control the interactive functionality of the contact control by defining other actions or activities that will occur when the contact control is clicked on.

One benefit of providing an interaction model for interacting with the contact controls, as described above, is that a user does not have to learn numerous different interaction models for various applications. According to one embodiment, the interaction model for interacting with the contact controls includes a response to a right mouse click and a response to a double mouse click. The right mouse click on the contact control, for example, launches a context menu of tasks (e.g., cut, copy, paste, delete, save to my address book, and so forth) that may be performed on or with the contact control. The double mouse click on the contact control launches a full contact details page, containing various contact information about the contact, as described above. It will be appreciated, however, that this interaction model may be modified to accommodate any desired need or preference.

Information Picker/Persona Interfaces

According to one embodiment, a contact is associated with various personas or profiles that each define a person in a unique way. Accordingly, a person can have, although not necessarily, multiple personas that are each associated with different contact information about the person. Examples of the personas can include, but are not limited to, a family persona, a school persona, a friends persona, a work persona, a recreational persona, a business persona, an e-commerce persona, an anonymous persona, and a personal persona. The various personas and their corresponding contact information can be stored in tables, indexes and other data structures that are stored in the contact store. According to this embodiment, the contact definition or persona represents a user to one or more calling applications, as specified by the user.

In particular, the personas can be created or modified by the user, as described below, or implicitly defined by the user's interaction with various applications. For example, if an application has previously asked for and obtained a user's home telephone number and address, the modules of the invention can enable such information to be tracked and automatically used to develop a corresponding profile or persona for the user.

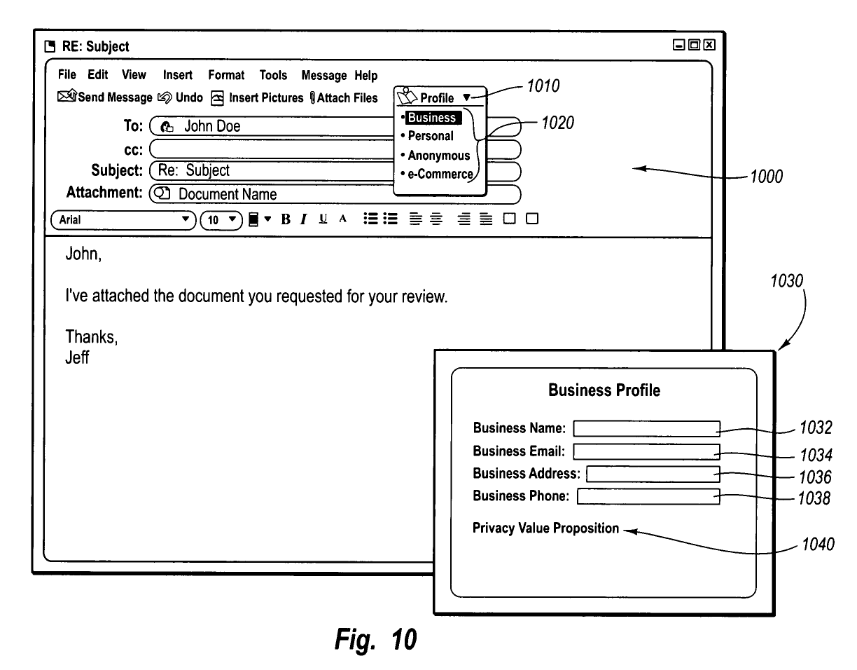

In one embodiment, the available personas are presented through an interface object 1010 that is integrated within the interface of the requesting application. For example, in FIG. 10, an e-mail application interface 1000 is shown to have an integrated profile menu object 1010 that can be selected to display one or more personas. Integrating the interface object can be performed, for example, by actually modifying the application's Graphical User Interface (GUI) or by simply overlaying the GUI with the interface object 1010.

Although the interface object 1010 can be integrated within the interfaces of existing applications, it will be appreciated that in other embodiments, the interface object can also comprise a separate stand alone interface that is presented independently to the user.

FIG. 10 illustrates four distinct personas corresponding to a contact, namely, a business persona, a personal persona, an anonymous persona and an e-commerce persona, although others may also be included. As described above, each of these personas can be associated with corresponding contact information about a single user that the user may decide is relevant and appropriate for different applications.

To protect contact information that may be confidential, such as, for example, personal identification numbers, social security numbers, bank account numbers, etc., security modules can also be provided to prevent a user from accessing or utilizing the personas of different users unless they have been authorized to do so. Such authorization may require the user to log in or to provide other certain information to verify their identity.

In the present example, an e-mail application has requested contact information about the user that will be included in metadata and headers for outgoing mail. The user may not have been made aware of this, but upon seeing the profile interface object 1010, the user can be informed that the application is seeking certain information. To provide even more notice to the user, the interface object 1010 can be displayed in an even more notorious or evident manner.

The user can be further informed about the information the application is seeking through a separate interface, such as, for example, the information picker interface 1030, which can be launched from the interface object 1010 or that can be automatically launched when the applications requests information.

It can be useful to notify the user of an application's request for information because some requests are not explicitly made to the user, but instead are made to the user's computing system without the user's express knowledge. Likewise, some requests for information are made at times that predate the user's ultimate use of an application, such that a reminder to the user of the application's request for information can be useful.

The information picker interface 1030 can be used to select the contact information that is associated with a persona or profile and that will be made available to an application. This interface 1030 can be launched automatically in response to a request for information, or, alternatively, in response to a specific request by the user. For example, the user can specifically request the interface at any time to develop and modify their corresponding personas. A user can also request the interface 1030 indirectly by selecting a persona from the interface object 1010, as described above. For example, in the present embodiment, the user has selected the business persona from the list of available personas 1020. This selection has caused the business profile or persona to be displayed in the information picker interface 1030.

The business profile currently includes fields for a business name (1032), e-mail address (1034), physical address (1036), and phone number (1038), each of which can be populated with the appropriate information. This information can be added at any time, prior to the application requesting the information, or after. This information can also be modified by a user at the interface 1030.

The types of information that are presented in the interface 1030 can be limited to the specific information being requested by the application or, more broadly, can include all types of related contact information that is associated with the user's corresponding persona and that is stored in the contact store.

The interface can also include additional information, such as the privacy value proposition 1040 of the application and/or of the application's owners that will inform the user what the contact information will be used for. This privacy and use information can be directly included in the interface 1030, or, alternatively, it can be linked to from one or more objects, such as a hyperlink, that are provided by the interface 1030. The privacy and use information can be specifically requested by the modules of the present invention as a prerequisite to providing the requested contact information to the applications. Alternatively, this information can be voluntarily provided without request.

If at anytime the user wants to change the contact information that is being provided to the application, as reflected by the displayed information picker interface 1030, they can modify it through the interface 1030. These preferences can then be stored in the contact store for subsequent reference.

The appropriate contact information that has been requested by an application is then presented in the appropriate format to the requesting application. What is considered appropriate is generally application specific and corresponds to the application's specific request as well as the persona that was selected by the user. By way of example, the appropriate contact information for an e-mail application could include the business e-mail address and business name of a user, if the user has specifically selected that the business persona be used to satisfy the application's request for information.

It will be appreciated that by doing this, the user can control what information is published and used by the application. For example, the outgoing messages will include only the user's business name and e-mail address to identify the sender. Likewise, if the user were to select the anonymous persona for a new e-mail, the new outgoing e-mail would then include an anonymous e-mail address and name that would not identify the sender or that would only identify the sender in some anonymous way.

Although the previous example is provided with respect to e-mail functionality, it will be appreciated that the scope of the invention extends to other embodiments in which contact information is utilized by other application to enable different functionality. For example, other applications may utilize the methods and interfaces of the invention include applications that use contact information to initiate a telephony session, initiate a telephone call, initiate a network connection, initiate a gaming session, access a website, perform a financial transaction, send material goods via postal mail, and so forth. These applications can be hosted by the user's computing system or by a remote computing system.

In summary, it will be appreciated that the present invention, as it has been described, overcomes many of the problems with managing contact information. In particular, contacts are stored in a centralized contact store from which all other directories can be synchronized. Various interfaces also provide controlled access and utilization of the contact information.

Computing Environment

It will be appreciated by those skilled in the art that the invention may be practiced in computing systems and network computing environments with various configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

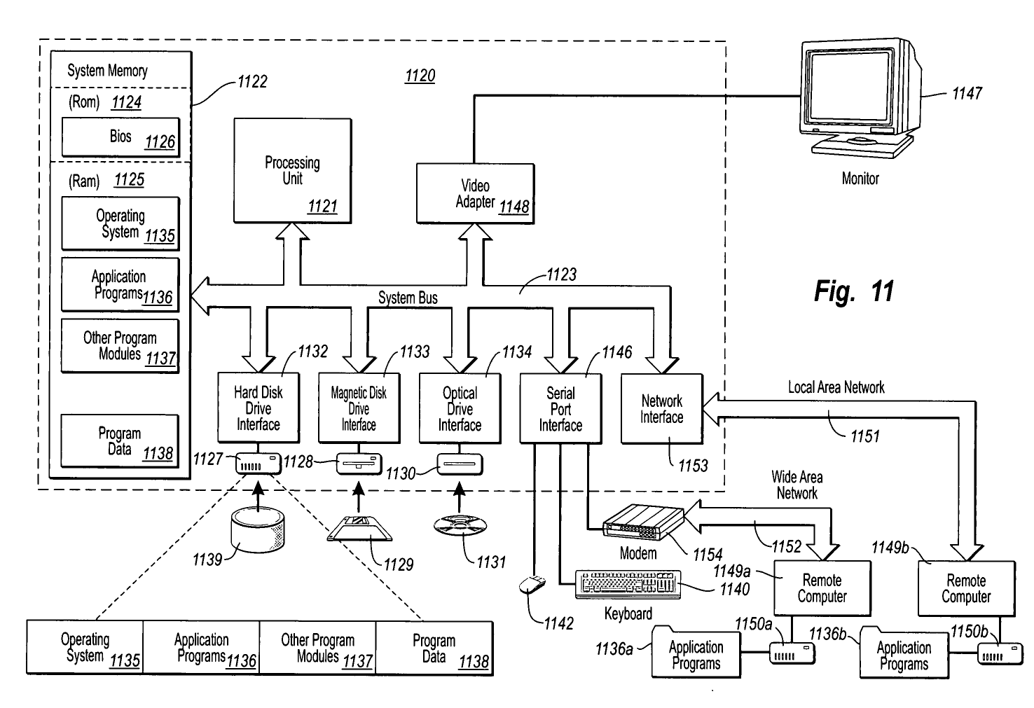

With reference to FIG. 11, an exemplary system that can be used, for example to develop aggregate user preference data and to perform many of the other acts and steps of the invention is provided. The illustrated system includes a general purpose computing device in the form of a conventional computer 1120, including a processing unit 1121, a system memory 1122, and a system bus 1123 that couples various system components including the system memory 1122 to the processing unit 1121. The system bus 1123 may be any of several types of bus structures including a memory bus or memory controller, a peripheral bus, and a local bus using any of a variety of bus architectures. The system memory includes read only memory (ROM) 1124 and random access memory (RAM) 1125. A basic input/output system (BIOS) 1126, containing the basic routines that help transfer information between elements within the computer 1120, such as during start-up, may be stored in ROM 1124.

The computer 1120 may also include a magnetic hard disk drive 1127 for reading from and writing to a magnetic hard disk 1139, a magnetic disk drive 1128 for reading from or writing to a removable magnetic disk 1129, and an optical disk drive 1130 for reading from or writing to removable optical disk 1131 such as a CD-ROM, DVD-ROM or other optical media. The magnetic hard disk drive 1127, magnetic disk drive 1128, and optical disk drive 1130 are connected to the system bus 1123 by a hard disk drive interface 1132, a magnetic disk drive-interface 1133, and an optical drive interface 1134, respectively. The drives and their associated computer-readable media provide nonvolatile storage of computer-executable instructions, data structures, program modules and other data for the computer 1120. Although the exemplary environment described herein employs a magnetic hard disk 1139, a removable magnetic disk 1129 and a removable optical disk 1131, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 1139, magnetic disk 1129, optical disk 1131, ROM 1124 or RAM 1125, including an operating system 1135, one or more application programs 1136, other program modules 1137, and program data 1138. A user may enter commands and information into the computer 1120 through keyboard 1140, pointing device 1142, or other input devices (not shown), such as a microphone, joy stick, game pad, satellite dish, scanner, or the like. These and other input devices are often connected to the processing unit 1121 through a serial port interface 1146 coupled to system bus 1123. Alternatively, the input devices may be connected by other interfaces, such as a parallel port, a game port or a universal serial bus (USB). A monitor 1147 or another display device is also connected to system bus 1123 via an interface, such as video adapter 1148. In addition to the monitor, personal computers typically include other peripheral output devices (not shown), such as speakers and printers.

The computer 1120 may operate in a networked environment using logical connections to one or more remote computers, such as remote computers 1149a and 1149b. Remote computers 1149a and 1149b may each be another personal computer, a server, a router, a network PC, a peer device or other common network node, and typically include many or all of the elements described above relative to the computer 1120, although only memory storage devices 1150a and 1150b and their associated application programs 1136a and 1136b have been illustrated in FIG. 11. The logical connections depicted in FIG. 11 include a local area network (LAN) 1151 and a wide area network (WAN) 1152 that are presented here by way of example and not limitation. Such networking environments are commonplace in office-wide or enterprise-wide computer networks, intranets and the Internet.

When used in a LAN networking environment, the computer 1120 is connected to the local network 1151 through a network interface or adapter 1153. When used in a WAN networking environment, the computer 1120 may include a modem 1154, a wireless link, or other means for establishing communications over the wide area network 1152, such as the Internet. The modem 1154, which may be internal or external, is connected to the system bus 1123 via the serial port interface 1146. In a networked environment, program modules depicted relative to the computer 1120, or portions thereof, may be stored in the remote memory storage device. It will be appreciated that the network connections shown are exemplary and other means of establishing communications over wide area network 1152 may be used.

It will be appreciated that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In a computing system that is in communication with one or more applications that are configured to utilize contact information, a method for providing a contact management system for managing contacts and their corresponding contact information for use by the one or more applications, the method comprising:
creating one or more contacts having contact information that can be utilized by the one or more applications, such that the one or more applications can utilize the contact information;
storing the contacts in a contact store that is accessible to the computing system;
upon receiving a request from at least one of the applications for access to a contact and corresponding contact information, providing the at least one of the applications access to the contact and corresponding contact information through one or more interfaces;
enabling the at least one of the applications to utilize the contact.

2. A method as recited in claim 1, wherein the one or more interfaces prevent the at least one of the applications from having direct access to the contacts and corresponding contact information in the contact store.

3. A method as recited in claim 2, wherein the interfaces further provide a security mechanism for preventing the at least one of the applications from accessing contacts and corresponding contact information that a corresponding user of the computing system has not authorized.

4. A method as recited in claim 3, wherein the corresponding user is a logged on user of the computing system.

5. A method as recited in claim 1, wherein enabling the at least one of the applications to utilize the contact includes enabling the at least one of the applications to update the contact information of the contact within the contact store.

6. A method as recited in claim 5, wherein the contact information is updated by syncing the contact information in the contact store with contact information provided by the at least one of the applications.

7. A method as recited in claim 1, wherein enabling the at least one of the applications to utilize the contact includes updating contact information stored by the at least one of the applications in an application store with the corresponding contact information from the contact store.

8. A method as recited in claim 1, wherein enabling the at least one of the applications to utilize the contact includes enabling the contact to be sent to another store of another computing system.

9. A method as recited in claim 1, wherein enabling the at least one of the applications to utilize the contact includes enabling the at least one of the heterogeneous application to modifying the contact.

10. A method as recited in claim 9, wherein modifying the contact includes modifying an attribute associated with the contact.

11. A method as recited in claim 1, wherein enabling the at least one of the applications to utilize the contact includes enabling the at least one of the applications to create an association between the contact and at least one other contact.

12. A method as recited in claim 1, wherein enabling the at least one of the applications to utilize the contact includes enabling the at least one of the applications to initiate a communication by using the contact information associated with the contact.

13. A method as recited in claim 12, wherein the communication includes at least one of an e-mail, a telephony session, an RTC session, an instant message, a facsimile, a telephone message and a pager notification.

14. A method as recited in claim 1, wherein creating the contact includes merging contact information corresponding to a single person and that is obtained from a plurality of sources into a single contact.

15. A method as recited in claim 1, wherein the contact comprises a data structure having a plurality of fields that contain different contact information, and wherein the one or more applications are configured to utilize contact information from different fields of the contact data structure.

16. A method as recited in claim 1, wherein the at least one of the applications is hosted by the computing system.

17. A method as recited in claim 1, wherein creating the contact includes enabling the user to set constraints that control how the contact can at least one of be accessed and utilized by applications.

18. A method as recited in claim 1, wherein the one or more interfaces includes an interface for enabling a user to select portions of the contact information that will be made accessible to the at least one of the applications.

19. A method as recited in claim 1, wherein the one or more interfaces includes an interface for enabling a user to select the contact from a plurality of available contacts.

20. A computer program product for use in a computing system that is in communication with one or more heterogeneous applications that are configured to utilize contact information differently, the computer program product comprising one or more computer-readable media having computer-executable instructions for implementing a method for providing a contact management system for managing contacts and their corresponding contact information for use by the one or more applications, the method comprising:
creating one or more contacts having contact information that can be utilized by the one or more applications, such that the one or more applications can utilize the contact information;
storing the contacts in a contact store that is accessible to the computing system;
upon receiving a request from at least one of the applications for access to a contact and corresponding contact information, providing the at least one of the applications access to the contact and corresponding contact information through one or more interfaces;
enabling the at least one of the heterogeneous applications to utilize the contact.

21. A computer program product as recited in claim 20, wherein the one or more interfaces prevent the at least one of the applications from having direct access to the contacts and corresponding contact information in the contact store.

22. A computer program product as recited in claim 21, wherein the interfaces further provide a security mechanism for preventing the at least one of the applications from accessing contacts and corresponding contact information that a corresponding user of the computing system has not authorized.

23. A computer program product as recited in claim 20, wherein enabling the at least one of the applications to utilize the contact includes enabling the at least one of the applications to update the contact information of the contact within the contact store.

24. A computer program product as recited in claim 20, wherein enabling the at least one of the applications to utilize the contact includes updating contact information stored by the at least one of the applications in an application store with the corresponding contact information from the contact store.

25. A computer program product as recited in claim 20, wherein enabling the at least one of the applications to utilize the contact includes enabling the contact to be sent to another store of another computing system.

26. A computer program product as recited in claim 20, wherein enabling the at least one of the applications to utilize the contact includes enabling the at least one of the applications to modifying the contact.

27. A computer program product as recited in claim 20, wherein enabling the at least one of the applications to utilize the contact includes enabling the at least one of the applications to create an association between the contact and at least one other contact.

28. A computer program product as recited in claim 20, wherein enabling the at least one of the applications to utilize the contact includes enabling the at least one of the applications to initiate a communication by using the contact information associated with the contact.

29. A computer program product as recited in claim 20, wherein creating the contact includes merging contact information corresponding to a single person and that is obtained from a plurality of sources into a single contact.

30. A computer program product as recited in claim 20, wherein the contact comprises a data structure having a plurality of fields that contain different contact information, and wherein the one or more applications are configured to utilize contact information from different fields of the contact data structure.

31. A computer program product as recited in claim 20, wherein the at least one of the applications is hosted by the computing system.

32. A computer program product as recited in claim 20, wherein creating the contact includes enabling the user to set constraints that control how the contact can at least one of be accessed and utilized by applications.

33. A computer program product as recited in claim 20, wherein the one or more interfaces includes an interface for enabling a user to select portions of the contact information that will be made accessible to the one or more applications.

34. In a computing system that includes a contact store storing at least one contact, the contact comprising contact information that can be utilized differently by heterogeneous applications that are in communication with the computing system, the heterogeneous applications having application contact directories that are maintained independently of the contact store and that defines the at least one contact, a method for providing a contact management system for managing contacts and their corresponding contact information for use by the heterogeneous applications, the method comprising:
creating one or more contacts having contact information that can be utilized differently by at least two heterogeneous applications;
storing the contacts in a contact store that is accessible to the computing system;
modifying contact information for at least one of the contacts in the contact store;
upon modifying the contact information, automatically updating corresponding contact information in at least one application contact directory of at least one of the heterogeneous applications to correspond with the modified contact information in the contact store, and such that the at least one application is able to access the updated contact information without having to request the updated contact information from the contact store.

35. A method as recited in claim 34, wherein modifying the contact information includes modifying content of the contact information.

36. A method as recited in claim 35, wherein modifying the contact information is performed by a local application hosted by the computing system.

37. A computer program product for use in a computing system that includes a contact store storing at least one contact, the contact comprising contact information that can be utilized differently by heterogeneous applications that are in communication with the computing system, the heterogeneous applications having application contact directories that are maintained independently of the contact store and that defines the at least one contact, the computer program product comprising one or more computer-readable media having computer-executable instructions for implementing a method for providing a contact management system for managing contacts and their corresponding contact information for use by the heterogeneous applications, the method comprising:
creating one or more contacts having contact information that can be utilized differently by at least two heterogeneous applications;
storing the contacts in a contact store that is accessible to the computing system;
modifying contact information for at least one of the contacts in the contact store;
upon modifying the contact information, automatically updating corresponding contact information in at least one application contact directory of at least one of the heterogeneous applications to correspond with the modified contact information in the contact store, and such that the at least one application is able to access the updated contact information without having to request the updated contact information from the contact store.

38. A computer program product as recited in claim 37, wherein modifying the contact information includes modifying content of the contact information.

39. A computer program product as recited in claim 37, wherein modifying the contact information is performed by a local application hosted by the computing system.

40. In a computing system that is in communication with at least two heterogeneous applications that are configured to utilize contact information differently, a method for providing a contact management system for managing contacts and their corresponding contact information for use by the at least two heterogeneous applications, the method comprising:
creating one or more contacts having contact information that can be utilized differently by at least two heterogeneous applications, such that the at least two heterogeneous applications can at least one of utilize different portions of the contact information and utilize the same portions of contact information in different ways;
storing the contacts in a contact store that is accessible to the computing system;
upon receiving a request from at least one of the heterogeneous applications for access to a contact and corresponding contact information, providing the at least one of the heterogeneous applications access to the contact and corresponding contact information through one or more interfaces;
enabling the at least one of the heterogeneous applications to utilize the contact.
